(19) United States
(12) Patent Application Publication
(10) Pub. No.: US 2012/0197699 A1
(43) Pub. Date: Aug. 2, 2012

(54) TRADE-IN VEHICLE VALUE OPTIMIZING SYSTEMS AND METHODS FOR SELLERS, BUYERS, AND DEALERSHIPS

(76) Inventors: Lloyd D. Snell, Ames, IA (US); Brad M. Rosenhamer, Ames, IA (US)

(21) Appl. No.: 13/363,582

(22) Filed: Feb. 1, 2012

Related U.S. Application Data
(60) Provisional application No. 61/438,642, filed on Feb. 1, 2011.

(51) Int. Cl. G06Q 30/08; G06Q 30/02

(52) U.S. Cl. 705/14.11; 705/26.3

(57) ABSTRACT

Computer-implemented methods and computer systems for offering vehicles, which are subject to sale agreements between sellers and buyers, on online markets and soliciting additional offers for these vehicles by third parties. This additional offering may generate additional revenues, above the agreed upon prices between the initial seller and buyer, and these revenues can be shared by sellers, buyers, and service providers. For example, a seller may contract with a dealer to sell a used car for a certain price, which may be a part of a trade-in transaction. Information about the car, including a price, is then posted on a website. Third parties may view this information and post their offers, which are higher than the initial contract price. The new higher offer may be accepted and the proceeds may be shared by sellers, buyers, and service providers.

### CROSS-REFERENCE TO RELATED APPLICATIONS

This application claims priority of U.S. Provisional Application No. 61/438,642, titled “TRADE-IN VEHICLE VALUE OPTIMIZING SYSTEMS AND METHODS FOR SELLERS, BUYERS, AND DEALERSHIPS,” filed 1 Feb. 2011 (docket no. SR20110201), which is incorporated herein by reference in its entirety for all purposes.

### FIELD

This application relates generally to online market places and more specifically to computer-implemented methods and computer systems for offering vehicles, and more particularly, to systems and methods for trade-in of vehicles, for offering vehicles that may be subject to existing sale agreements between sellers and buyers, on online markets and soliciting additional offers for these trade-in vehicles by third parties.

### BACKGROUND

Every day tens of thousands of people enter vehicle purchasing transactions wherein the value of a used vehicle is applied towards the price of a different vehicle, which may or may not be new. A trade-in transaction typically involves a single new vehicle buyer, who is also a trade-in seller, and a single dealer, who is also a new vehicle seller (dealer) and the trade-in buyer. The transaction normally occurs at the new vehicle dealer's place of business (e.g., a dealership). Trade-in transactions are included in 70-80% of all transactions for purchases of motorized vehicles, recreational vehicles, boats, motorcycles, and agricultural equipment in United States of America.

Dealership trade-ins are typically represented by a “closed” type of transactions as there is only one seller and one buyer. A trade-in transaction may be desirable by a seller because there is no need to find a buyer for the seller's used vehicle prior to the purchase of a new vehicle. In this case, the dealer is the buyer of the trade-in vehicle. Finding a buyer is often a stressful process that includes finding a buyer, showing the vehicle to many potential buyers, negotiating a price, performing a secure monetary transaction, and completing financial and regulatory documentation. Additionally, trading-in also simplifies the disposal of a vehicle with mechanical, cosmetic, and/or a history of issues that may potentially reduce the value of the vehicle. Additional economic advantages of the trading-in process may include reducing the sales tax burden with direct application of the vehicle trade-in value to the new vehicle. Therefore, trade-in transactions save seller's time and reduce effort and financial risk associated with disposing of a used vehicle independently. In return for trading in, the seller must accept a wholesale or a below wholesale valuation.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer-implemented methods and computer systems for offering vehicles, which can be subject to the existing sale agreements between sellers and buyers, can be on online markets and can be in the process of soliciting additional offers for these vehicles from third parties. This offer process may generate additional revenues, above the agreed upon seller and buyer transaction amount, and these revenues could be shared by seller(s), buyer(s), and a service provider. For example, a seller may receive an offer from a dealer to buy a used car (trade-in) for a certain price. This offer may be a part of a trade-in transaction. Information about the car, including the initial offer price, repairs, dealer overhead, and an initial dealer offer price is calculated and then higher offer prices are posted on a vehicle sale forum, e.g., a website. Third parties may view this information and select their offer or offers, which are higher than the initial dealer offer price. However, in this situation, the dealer may be released from the sales agreement with the seller or may be required to sell the vehicle to the buyer with the higher offer by contractual obligations of the sale agreement with the trade in seller. The process described herein for additional offers may be limited, e.g., in time, scope or dollar levels.

In certain embodiments, a computer-implemented method for offering a vehicle under a sale agreement that provides for further offers involves a sale agreement to sell the vehicle at a set price and before executing the sale, listing the vehicle from the dealer to new buyer by use of a sales forum. The sales forum can be electronically controlled in a machine environment. The sale agreement may include a sale price for the vehicle and information about the vehicle. The method may also involve posting the sale prices of the vehicle and information about the vehicle on a sale forum accessible to buyers. The post may be presented on a forum for a predetermined offering period, for example, a matter of hours, a day, days, (e.g., five days) or a week. The method may also include providing a viewing interface for viewing the sale price for the vehicle and information about the vehicle. The viewing interface may represent a part of the sale forum accessible to the potential third party buyers. The method may also include providing an offering interface for posting one or more offers from the buyers during a predetermined offering period. The offering interface may represent a part of the sale forum accessible to the buyers. In certain embodiments, the same interface may serve as a viewing interface and an offering interface. Each of the one or more offers may be associated with an offering price for the vehicle that is higher than the sale value. If an offer is posted, the method may proceed with automatically selecting a first and highest buyer that posted a highest offer price for the vehicle. There may be one or more offers posted. If the highest offer is automatically selected, the method may proceed with instructing the buyer (dealer) to transfer the vehicle to the first and highest offer buyer. It will be understood that the systems and methods described herein are not limited to a specific type of vehicle and may, in some example embodiments, include a car, truck, boat, motorcycle, and farming equipment. Similarly, the buyer is not limited to an individual and may include a business entity (e.g., a third party car dealership) as well.

In certain embodiments, the computer-implemented method may also include connecting the vehicle from the seller to the buyer prior to posting the sale price and information concerning the vehicle as a trade in vehicle with a sales contract. In an embodiment, the method may involve, prior to receiving the sale agreement, posting initial vehicle information provided by the seller for a predetermined offer period. The initial vehicle information may be viewable through the viewing interface of the sale forum. The initial vehicle information may be distinguishable from the price of the vehicle and the information concerning a vehicle provided in the sale agreement within the viewing interface of the sale forum. For example, vehicles that have only initial vehicle information and no sale agreements may have their status indicated as such (e.g., “for sale by owner” or “fleet sale” status). In the same or other embodiments, vehicles that have corresponding sale agreements may have special tags (e.g., “trade in”, “wholesale”, “fleetsale”). This differentiation may indicate to a viewer a pricing flexibility. That is, a viewer may contact the seller to offer a different than listing price for a vehicle that is not under a sales agreement than for the one posted on the forum as “trade in” or “wholesale”. At the same time, there is not guarantee that this price will be accepted by the seller. When a vehicle is under a sale agreement, a viewer (buyer) may only offer a price that is higher than the one posted (i.e., the sale price under the agreement). In this case, the viewer may be guaranteed to buy the vehicle for this price (assuming no higher offers are posted and the buyer is the earliest offer at the highest offer). In certain embodiments, the computer-implemented method may also include, a method to transfer information from one state to the next, i.e., from “for sale by owner” to “trade in”, or “trade-in” to “wholesale”, or “fleetsale” to “wholesale”.

In certain embodiments, the information regarding the vehicle included in the sale contract has one or more of the following pieces of information: a vehicle identification number, vehicle make, vehicle model, vehicle mileage, a vehicle location, a vehicle photo(s), vehicle condition information, and an estimated market value. The predetermined offering period may be set to a specific number of days (e.g., five days). In other embodiments, the predetermined offering period may be a part of the sale agreement and is agreed upon by the seller and the buyer (dealer). The seller and the buyer (dealer) may negotiate the offering period as a part of the overall transaction (e.g., determining the vehicle price). In certain embodiments, the sale agreement may be received from the seller. The seller may use a seller interface to enter the information provided in the sale agreement, such as the agreed upon sale price and information concerning the vehicle. The sale forum may include one or more webpages for uploading the sale agreement, providing the viewer interface, and/or providing the offering interface. The viewing interface may present information on vehicle's location and vehicle's availability for viewing by potential bidders or buyers.

In certain embodiments, the computer-implemented method also includes instructing the highest and winning buyer (who accepts the offer or offers a higher offer) to pay a portion of the highest offer to the service provider. This value, the service provider fee, is the amount of the highest offer less the initial trade in value an may be a flat fee, a set percentage of the difference (e.g., 6% or more of the difference), or some other percentage of the premium defined as a difference between the highest bidding price and sale price in the sales agreement, the “shared reward”. The percentage of the premium payable to the service provider may vary depending on the sale price of the vehicle (e.g., a lower percentage for a high priced vehicle), duration of the offering period, and other similar factors of the sales agreement. The buyer then completes the purchase of the vehicle at the listing dealer. The dealer, per the sales agreement, after completion of the purchase by the buyer with the highest offer makes a predetermined payment to the owner of the sales contract, e.g. the initial owner who traded in the vehicle. The remaining portion of the highest offering price corresponds to a difference between the highest offering price and the portion of the highest offering then remains with the dealer as additional shared reward.

In certain embodiments, the computer-implemented method may also include instructing the highest offer buyer to pay a sum corresponding to the highest offer price to the listing entity (e.g., the entity listing the vehicle, which can be the dealer). In this situation, the buyer does not transfer funds corresponding to the sale price prior to posting the sale price for the vehicle and the information concerning the vehicle on the sale while the forum is accessible. In other embodiments, the buyer transfers certain funds corresponding to the service provider fee at that time of the offer. At the end of the offering period, the computer-implemented method may include instructing the highest bidder to pay a sum corresponding to the premium to the listing entity (e.g., a dealer) and complete the service fee payment. The computer-implemented method at the same time releases all other potential buyers from the service fee payment obligation. As noted above, the computer-implemented method may also include instructing the highest offer buyer to pay a certain sum to the service provider, e.g., a percentage corresponding to the premium. The method may also involve collecting the highest offering price from the highest buyer. For example, a system used for execution of this method may involve a payment switch for collecting the fees from the highest bidder. The offering may be in the open format, i.e., offers posted through the offering interface during the predetermined offering period of offering time is viewable by others, or in the closed format, i.e., when the offers are not viewable by others until the end of the offering period and the completion of the purchase by the high offer buyer.

In certain embodiment, buyers can be registered as a general buyer and place offers on vehicles that are available for general purchase. Buyers can also be registered as registered dealers validated by state licenses. Dealer buyers will also be able to see vehicles listed as wholesale vehicles. Wholesale vehicles are restricted to dealer buyer only.

In certain embodiments, the dealer can chose to transfer the trade in vehicle to either a listing of the forum as a trade in or as a wholesale listing. The trade in listing is available by all registered buyers.

In certain embodiments, the computer-implemented method may also re-offer” the vehicle to subsequent buyers based on an original time and value offered for the listed vehicle by a buyer. This process occurs when a winning buyer with the highest earliest offer is unable to complete the purchase from the dealer. The terms of the re-offer allows the dealer either purchase the vehicle at the next buyers terms, or have the computer-implemented method contact the next buyer at the original values the buyer offered. If a buyer accepts the re-offer, the buyer is then charged the service provider fee and instructed on the amount to be paid to the dealer. The dealer is again informed of the value to be paid to the initial trade-in seller.

In certain embodiments, the computer-implemented method may also be a method to allow buyers to save a vehicle they wish to purchase if it becomes available. The buyer save pieces of information: a make, model, value range, distance from their location, vehicle mileage range and saves the information. The computer-implemented then contacts the buyer when a vehicle matching the buyer's requirements is listed.

The computer-implemented system may include stationary, mobile, and personal electronic or communication systems.

In certain embodiments, the user to manage account information, manage vehicle activities, such as listing, selling, buying and transaction. In an example, the dealer as seller can alter a listing of a vehicle on the sales forum. The dealer as seller may change a listing from retail sale to wholesale by interacting remotely, for example through a computer network, with the server that runs the sales forum.

In certain embodiments, allows the buyer to search the listed vehicle information, e.g. on the sales forum, regarding the vehicle make, model, year range, and distance from search location, sales type, mileage range, body type, and price.

In further examples, the above methods steps are stored on a machine-readable medium including instructions, which, when implemented by one or more processors, perform the steps. In yet further examples, subsystems, or devices can be adapted to perform the recited steps. Other features, examples, and embodiments are described below.

The present methods and systems may result in a more efficient market for the sale of items and vehicles, and specifically, trade-in vehicles.

### BRIEF DESCRIPTION OF DRAWINGS

Example embodiments are illustrated by way of example and not limitation in the figures of the accompanying drawings, in which like references indicate similar elements and in which:

FIG. 1 illustrates a schematic overview of various modules of the system for offering a vehicle under a sale agreement for further offering, in accordance with certain embodiments.

FIG. 2 illustrates an example network segment for implementing various aspects of methods and systems for offering a vehicle under a sale agreement for further offering, in accordance with certain embodiments.

FIG. 3 illustrates an example network segment where some of the components of the system for offering a vehicle under a sale agreement for further bidding are virtualized, in accordance with certain embodiments.

FIGS. 4A and 4B are a process flowchart corresponding to computer-implemented method for offering an vehicle under a sale agreement for further bidding are virtualized, in accordance with certain embodiments.

FIG. 5 is a process flowchart of example of vehicles and fund flows between various participants, in accordance with certain embodiments.

FIG. 6 illustrates a viewing interface presenting different types of listings, in accordance with certain embodiments.

FIG. 7 illustrates an initial bidding interface, in accordance with certain embodiments.

FIG. 8 illustrates another bidding interface, in accordance with certain embodiments.

FIG. 9 is a diagrammatic representation of an example machine in the form of a computer system within which a set of instructions for causing the machine to perform any one or more of the methodologies discussed herein is executed.

### DETAILED DESCRIPTION

The present inventors have identified at least two problems with the traditional vehicle trade-in process. The first problem is the lack of multiple buyers trying to purchase the vehicle. The current standard trade-in transaction occurs between two parties, the seller and the car dealership. This negotiation process generally provides the dealer with an advantage. Introduction of additional buyers into this otherwise monopolistic (from the buyer perspective) transaction may result in a higher value or verification of paid value for vehicles. Without multiple buyers, there is no mechanism to bring the value of the trade-in vehicles towards a tested true market value. The second problem is the lack of time to introduce additional buyers to the transaction. Since the traditional trade-in process involves “closed” negotiations, there is no possibility or desire by dealers to find additional buyers. The only options the seller may have are to accept the amount the dealer has offered, which can be a below market offer or perceived to be a below market offer, start over with another dealer, or sell the vehicle themselves. Closed negotiations increase the advantage the dealer has in manipulating the financial outcome.

As used herein, the term “seller” is used to identify a party who owns an item or vehicle to be sold using the present methods and systems. The seller can be the current owner of the item or vehicle. The seller can be a trade-in seller who is transferring title to the item or vehicle as part of an exchange or purchase of another item or vehicle. The seller may be an individual or a company. One example of a company is a dealer, e.g., an auto dealership. The term “buyer” is used to identify a party who acquires ownership of the item or vehicle being sold by the seller. In the course of selling the item or vehicle using the methods and systems described herein, a party may only be the seller, buyer or both. For example, a dealer may acquire an item from a seller, who may be a straight seller (e.g., a for sale by owner seller) or a trade-in seller. The dealer then becomes the seller of the item or vehicle. A new buyer then acquires the item or vehicle from the dealer, who is now the seller.

The present methods and systems may also include a service provider. The service provider may be involved in bringing buyers and sellers together, e.g., through offerings as described herein. The service provider may have a contractual relationship with certain sellers, e.g., dealers. The service provider may have a contractual relationship with certain buyers, e.g., another dealer, a company or an individual. The contractual relationship may be required to use the methods or systems provided by the service provider.

Example systems and methods for offering a vehicle under a sale agreement for further offers are described. In the following description, for purposes of explanation, numerous specific details are set forth in order to provide a thorough understanding of example embodiments. It will be evident, however, to one skilled in the art, that the present invention may be practiced without these specific details.

A brief description of computer-implemented methods and computer systems for offering vehicles, which may subject to existing sale agreements between sellers and buyers (e.g., between a trade-in seller and a dealer-buyer), on online markets and soliciting additional offers for these vehicles by a third party (e.g., potential third party buyers) are provided. The examples are generally referred to a car sale in the context of a trade-in transaction. However, one having ordinary skills in the art would understand that these methods and systems may be used to generate additional revenues for buyers and sellers of other items or vehicles, such as boats, aircraft, motorcycles, farming equipment, construction equipment, and the like. Furthermore, the present inventors recognize that the methods and systems described herein may be used to generate additional revenues for buyers and sellers of non-transportation (e.g., non-vehicle) assets, such as Computer Numeric Controlled (CNC) machinery, manufacturing equipment, computer equipment, or any asset which is used as part of a trade-in transaction, partial payment for an asset of like kind. As a general example, a seller may contract with a dealer to sell a car for a certain value (i.e., the trade-in value). At this point, the seller may be concerned if the trade-in value of this agreement is fair, while the dealer's best value may be moving this car out of its inventory. To address these concerns and to potentially generate additional revenue, computer-implemented methods and computer systems to post information about the car, including the trade-in value in an example, on a website. Third parties may view this information and select an offer value for the vehicle. Such an offer is more than the trade-in value in the contracted sales agreement between the seller and buyer. In an example, the offer amounts are predefined by either the dealer or the service provider. In another example, the offer amounts are preset increments over the prior amount of an offer. If any offers are posted, the dealer is under contractual obligations under the sale agreement with the original seller to sell the vehicle to the highest offer posted by the service provider from a third party buyer for that offered value. The difference between the offer and the trade-in value may be shared by seller, buyer, and service provider or combinations thereof.

These computer-implemented methods and computer systems create additional purchasing opportunity for all buyers (e.g., dealers and third parties). For buyers who are individuals, the value of the vehicle offered through the present methods may be substantially below a retail price thus representing a financial advantage for the buyer. If the buyer is a dealer, the purchase may represent an opportunity to align a vehicle from a non-brand dealer to a brand dealer where parts, service, and sales support, such as manufacturer certification, financing, and brand loyal buyers represent a significant opportunity to make a profit that the non-brand dealer does not have.

The methods and systems may help dealers move cars faster (increase sales volume), attract money-in-hand third parties. The methods and systems may also reduce the likelihood that a seller is unsatisfied with interactions with a dealer over the trade-in process, trade-in values, or exiting the dealership prior to completion of a new vehicle purchase and sales agreement.

In certain embodiments, the computer-implemented methods and computer systems allow sellers to vet their options without dealer participants (e.g., in the “for sale by owner”) and then vet an offered value by any consumer on a market by allowing buyers to offer or negotiate, independent of the computer-implemented solution, a purchase price. The “for sale by owner” transactions often result in the seller achieve a significantly greater value than a typical trade-in transaction. Online market places provided by the computer-implemented methods and computer systems may attract additional buyers such as money-in-hand buyers, to purchase (e.g., accept offers) listed vehicles because of the low cost and high value of the listed vehicle and the short and competitive listing period. The online market place creates purchasing opportunity for any buyer, who may be more motivated to buy vehicles for more value than, for example, dealers. The high number of buyers who can access a sales listing on a computer network and within a competitive market forum assists trade-in vehicles in achieving a Vehicle-Best-Value (VBV) and assists in moving vehicles (which are quite often unwanted by dealers) off the initial dealer's lots. For purposes of this document, VBV is defines as a price a listed vehicle sells for in an open and highly competitive market places with access to information and method to engage multiple motivated money-in-hand buyers. The computer-implemented methods and computer systems provide various opportunities for vehicles to reach their VBV by presenting vehicle listings and information corresponding to these vehicles including their sale prices in a competitive online marketplace.

There may be three types of participants in these computer-implemented methods and computer systems: sellers (trade in or “for sale by owner”, initial buyers (dealers), and third parties (individual buyers, business buyers, money-in-hand buyers). For purposes of this document, third parties offering on vehicles, may also be referred to as money-in-hand buyers, are customers that are actively seeking to purchase a vehicle and is financially able to buy a vehicle. All parties may be required to register with the service provider before entering into any transactions. For example, parties may be required to provide name, address, email and phone. Parties may be required to create a password, which an email may be used as a username. The registration may be confirmed via an e-mail. The service provider may require credit checks and qualification to participate in the sales forum. A service provider may collect fees from one or more of these participants depending on the type of transaction. There may be no fee for registering with the service and/or listing a vehicle on one or more forums provided by the service. The fee may be collected, for example, as flat fee or a percentage (e.g., 1%-10% or, more specifically, about 6%), of the premium. Such registration may include a user computer and a server. The data regarding sellers, initial buyers, and third parties may be stored in a memory or database associated with the server.

A seller may provide certain information about the vehicle for sale. Providing this information may be through a seller's device, such a computer, handheld, tablet, mobile phone or other electronic device. After entering into a sale contract, additional information may be provided by the initial buyer (e.g., a vehicle dealer) as well. For example, a car dealer may provide additional photos, comments about condition of the car, and other information that may be useful for third parties while viewing the listing on the online market place. The car dealer may use an electronic device to provide or post the additional information, which can be stored and accessed from a memory or a database. Both buyers and sellers may be incentivized to generate additional offers on the vehicle.

Post sale agreement posting on an online market place may be for a certain predetermined offering period, which is referred herein as an offering period. In certain embodiments, this offering period is measured in days, e.g., three days, five days or less than two weeks. If no offers are received during this offering period, then the initial buyer (e.g., a dealer) retains the trade-in vehicle. When the initial buyer is a dealer, the dealer will attempt to monetize the vehicle by selling the wholesale market or attempting a quick sale. A seller, trade-in seller and dealer and/or dealer may be able to extend the predetermined offering period, for example, if no offers are generated or before any offers are started. That is the time duration of the offering period can be set by the seller, trade-in seller and dealer and/or dealer if doing so would not prejudice another party or if the other party agrees. Such an agreement may be arbitrated and stored by the service provider.

A seller may have an option of posting a listing with information about a vehicle before contacting a dealer. This option is referred to as a “for sale by owner” option. A seller may opt out of this option and proceed directly with negotiating sale or trade-in with a dealer. When sale agreement is reached between the dealer (initial buyer) and the seller, any prior listing is deleted and replaced by a “trade in” listing. Only the trade in listings by the dealer will include the dealer's contact information. A potential third party may contact the dealer for viewing the actual vehicle and, for example, testing the vehicle (i.e., test driving the car in the car sale context). Such listings are accessible through a computing system or electronic device. “Trade-in” listings may provide additional options that are specific to dealers, e.g., warranties, additional options, financing, and the like.

When a buyer places an offer for a vehicle, they may be charged a small deposit, which may be necessary to avoid unreasonable and even malicious offering strategies. When a buyer has the highest offer or best qualified offer, this person may be charged (e.g., a percentage of the premium or flat rate) by the service provider. The remaining balance may be payable to the dealer. In an embodiment, a portion of the remaining balance, if above set amount from the dealer, can be paid to the trade-in seller from the service provider. Various vehicle and finance transaction options are described below. Such financial accounting may occur with the computing system according to a formula to which the parties agree. The accounting may be performed automatically by the computing system.

Various specific embodiments of the present invention that may incorporate the above will now be described with reference to the drawings.

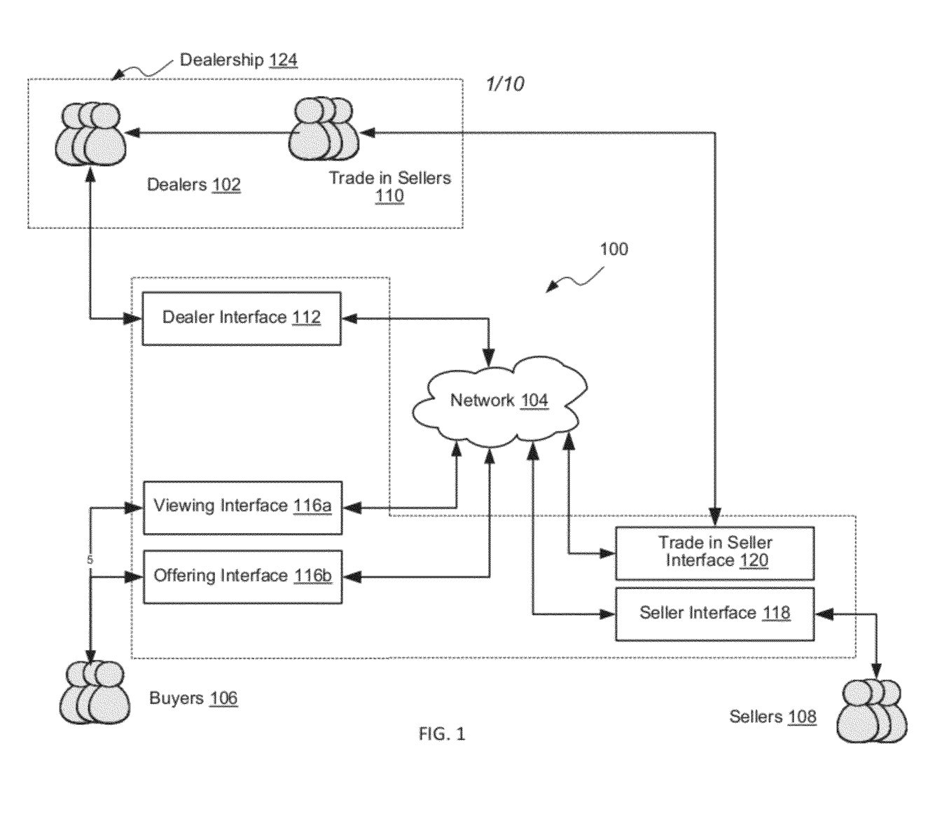

FIG. 1 is a schematic representation of system 100 for offering a vehicle under a sale agreement for further offers, in accordance with certain embodiments. As explained above, system 100 includes three types of participants. Seller 108 (“for sale by owner”) that introduce a vehicle for sale to buyers 106. Trade-in sellers 110 trade in a vehicle at a dealership 124 and the dealer lists the vehicle using the dealer interface 112. The initial buyer/dealer 102, buyers 106, and trade-in seller 110 and seller 108 may each include a computing device (electronic communication device) providing access to the system (e.g., computing/communication system) 100. Dealer 102 enters into a sale agreement with trade-in seller 110, after which the vehicle is offered on an online market place to buyers 106. Dealer 102 may also list the vehicle on the market place in the “wholesale” category and, therefore, offer the vehicle only to other dealers, e.g., other dealers 102. That is, only other dealers will see a wholesale vehicle on the sales forum of the service provider. This type of restriction is important to protect buyers and dealers from vehicles that represent unwanted safety risk or quality.

To enable various operations and functions further described below, system 100 may provide a series of interfaces. Seller 108 may be provided with seller interface 118 to provide some information about the vehicle, such as uploading photos, entering description, and providing contact information. This information may be used to create a “for sale by owner” listing, present the vehicle to a buyer 106. Dealer 102 may be provided with dealer interface 112 to add additional information about the vehicle, e.g., a sale price, information from the sale agreement, provide buyers' comments about the vehicle, manage trade in vehicle listings, manage wholesale vehicle listings, manage vehicle with buy offers, manage user and client user variables and information, manage and print reports for historical activity, offer additional options, financing, and other items that would be obvious. The dealer interface may be many or combinations of many different viewing interfaces. Buyers 106 may be provided with buyer or viewing interface 116a and/or offering interface 116b. In certain embodiments, functions of these interfaces are combined in a common interface. Viewing interface 116a is provided for viewing the sale price for the vehicle and information about the vehicle. Viewing interface 116a may be a part of the sale forum accessible to buyers 106. The offering interface 116b is provided for posting one or more offers from buyers 106 during a predetermined listing period. Offering interface 116b may be also a part of the sales forum accessible to buyers 106. The trade-in seller 110 may have a viewing interface 120 for monitoring the activity of a trade-in vehicle. These interfaces (i.e., seller interface 118, buyer interface 112, viewing interface 116a, and/or offering interface 116b) may allow respective users to register and login into the service. The interfaces can be generated by a server (computing system) and provided to electronic devices for the buyers/dealers, buyers, and sellers. The interfaces can include a memory to store data and instructions and a processor to execute the instructions and use the data. The system can be expanded to include new user function and interfaces through the use of instructions and data that can be executed by the processor or stored in the memory.

The viewing interface 116A may provide a robust user interface for potential buyers. In an example, the viewing interface 116A may store history of a user's search histories. The viewing interface 116A may create and store, in a memory, a saved-search at the server for the service provider or on the viewer's computer. The service provider may also provide an email or messaging function at the viewing interface 116A. The server of the service provider may, e.g., through a website, provide the user, at the user's computer, with immediate email notifications when a vehicle you are looking for is listed on the sales forum by the service provider. In an example, the saved search function can operate to save the user time by automatically login of the user onto the sales forum or server. The search criteria can be automatically filled. The user need only select an instruction button or activation icon to conduct a search, e.g., click search. The user can also instruct the sales forum or the serer to save a search, e.g., by clicking save search. In an example, the save search button or icon may be located above the search results. The user may store a set number of searches at a time, e.g., 5, 10, or more. In an example, the server of the service provider can automatically conduct the saved searches without the user being logged onto the system. The server can notify when a trade-in vehicle or for sale by owner vehicle is listed at the sales forum that matches your saved search. If a user does not wish ofr any notifications, the user can select an opt-out.

The saved-search feature is a quick and easy way to know when a vehicle the user may want is listed on the sales forum. In one example, the highest offer received first wins the listing and may purchase the vehicle. Using the saved-search tool can help the user place offers faster and get better deals on used vehicles at the sales forum.

Network 104 may be also used for communication among various interfaces of system 100. Network 104 may take any suitable form, such as a wide area network or Internet and/or one or more local area networks (LAN's). The network 104 may include any suitable number and type of devices, e.g., routers and switches, for forwarding commands, content, and/or web object requests from each client to the online community application and responses back to the clients.

The methods describe herein may also be practiced in a wide variety of network environments (represented by network 104) including, for example, TCP/IP-based networks, telecommunications networks, wireless networks, etc. In addition, the computer program instructions may be stored in any type of computer-readable media. The program may be executed according to a variety of computing models including a client/server model, a peer-to-peer model, on a stand-alone computing device, or according to a distributed computing model in which various functionalities described herein may be affected or employed at different locations.

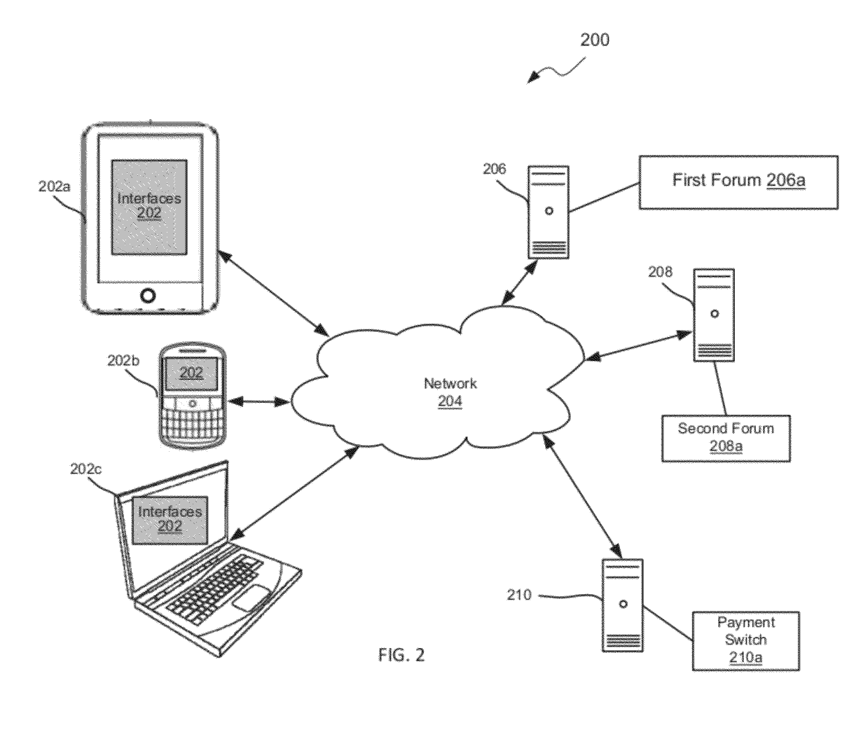

FIG. 2 illustrates an example network segment 200 for implementing various aspects of methods and systems for offering a vehicle under a sale agreement for further bidding, in accordance with certain embodiments. Network segment 200 includes various types of computer systems 202a, 202b, and 202c used by participants (i.e., sellers, buyers/dealers, and buyers) and providing different types of interfaces 202 described above. Computer systems 202a, 202b, and 202c communicate through network 204 with one or more servers 206, 208, and 210 used by a service provide and/or other services. For example, server 206 may be used to provide first forum 206a that may be used to support “for sale by owner” listings. Server 208 may be used to provide second forum 208a that may be used to support “trade in” listings. In certain embodiments, servers 206 and 208 may support different geographic markets, different types of vehicles (e.g., cars, boats, agricultural equipment), and other categories or other items for sale. Yet another server 210 may host payment switch 210a and used for processing payments from one or more participants as described above. Computer systems and servers may each include one or more processors that can each execute instructions to perform the presently described methods. The instructions can be sequentially executed in a single processor or executed in a distributed computing system on separate processing cores or physically different processors.

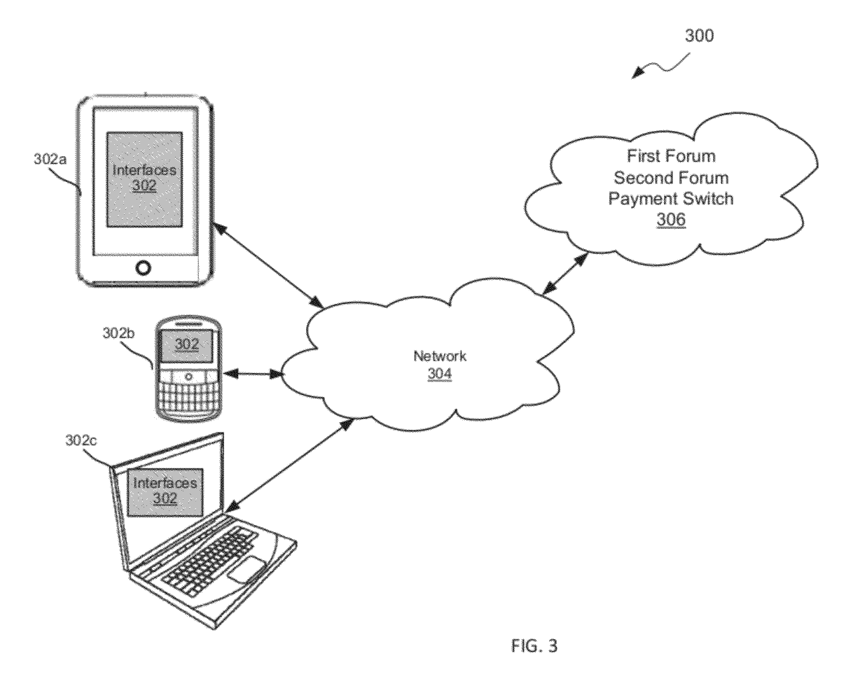

FIG. 3 illustrates an example network segment 300 where some of the components of the system for offering a vehicle under a sale agreement for further bidding are virtualized, in accordance with certain embodiments. Computer systems 302a, 302b, and 302c also provide different interfaces but these interfaces may be generated by cloud computing service 306, which may support different forums, payment switches, and other functions of the system.

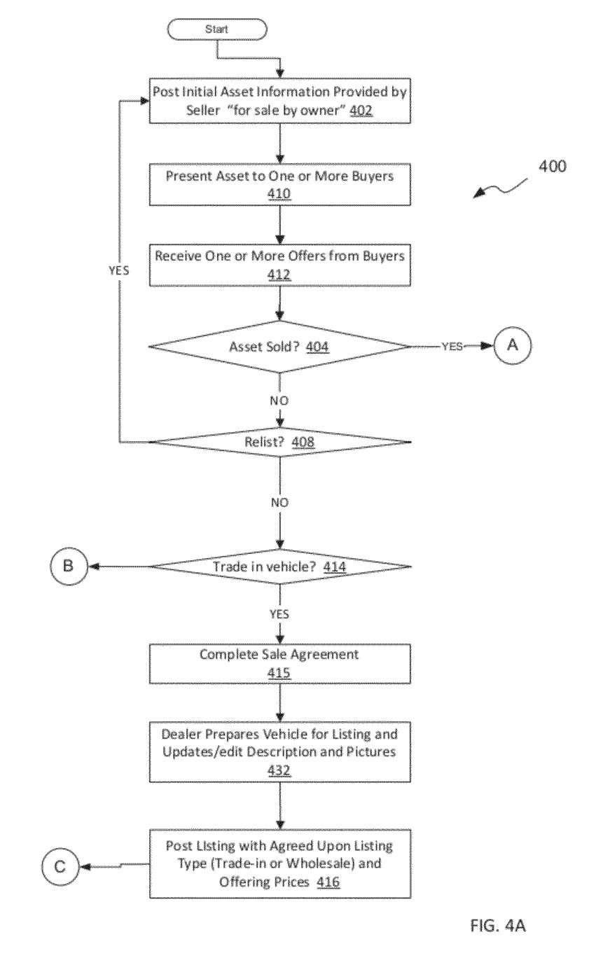

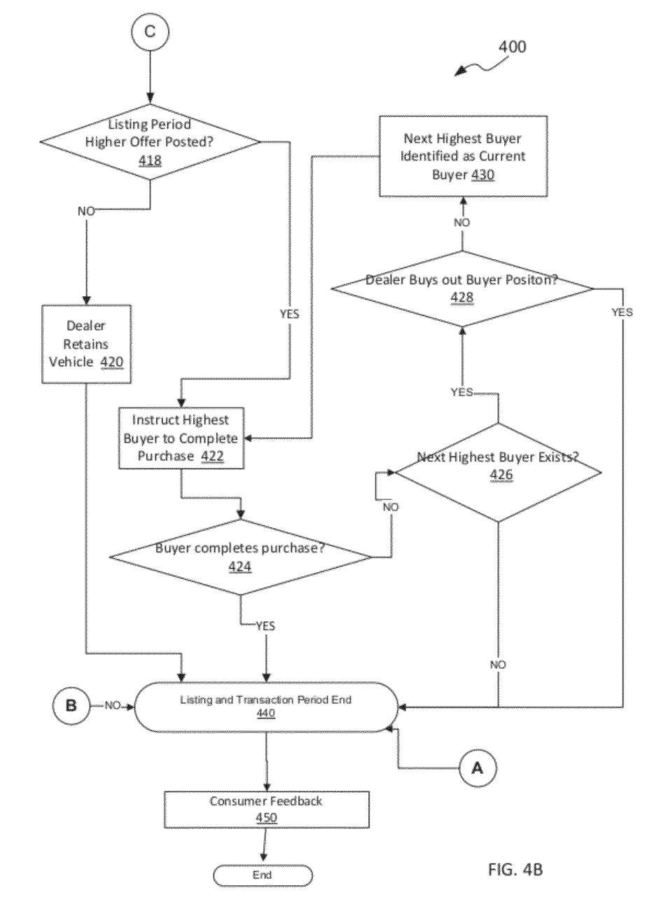

FIG. 4 is a process flowchart corresponding to computer-implemented method 400 for offering a vehicle either under a sale agreement for further offers, in accordance with certain embodiments or not under a sale agreement. Method 400 may start with a series of optional operations 402, 404, and 408, during which a seller of the vehicle may attempt to sell the vehicle (“for sale by owner”) on an open forum to all available buyers. Some examples of vehicles include a vehicle, boat, a motorcycle, and farming equipment.

The open forum may be the same forum as the sale forum used for later operations (e.g., operations 416 and 418) further described below or may be a different forum. When multiple vehicles are presented on the same forum, the vehicles may be distinguished based on their current participation in operations 402, 404, and 408 or in operations 416 and 418. For example, vehicles that are still being sold by owner during operations 402, 404, and 408 may have pricing flexibility, also known as the “for sale by owner” option. Pricing flexibility, on the other hand, trade-in vehicles and wholesale vehicles that are already under the sale agreement and are being sold by, for example, a dealer during operations 416 and 418 may have a price floor (e.g., the trade-in price in the sale agreement) and being open to higher prices, e.g., a set number of offer values between the trade-in amount and a high price that can be set by the dealer. In an example 5 or ten predetermined offer values are set. In an example these offer values are equally spaced. In an example the offer values get progressively greater in amount of spread between offers as the offers go up. The system may determine the offer values to be displayed on the buyer interface. Furthermore, when a vehicle moves from the “sale by owner” category to the “sale agreement” category, it may change its location, have more information associated with the vehicle (e.g., additional photos, description), and may be more available for inspecting by potential new buyers. Moreover, if the vehicle is listed as a “wholesale”, then the types of buyers are restricted. In other embodiments, a forum used for posting vehicle information during operations 402, 404, and 408 is different from the forum used for posting information contained in the sale agreement during operations 416 and 418.

Completing the purchase transaction may require multiple buyers if the initial, highest offer buyer is unable or fails to complete the purchase. In an optional embodiment if the selected highest buyer cannot complete the purchase 424, a next highest buyer is identified 426 at their original offered value. The dealer is then allowed two options 428: (1) buy out the next highest buyers position by paying the trade in seller's the portion of shared gain per the sales agreement. The vehicle then becomes the dealers and the trade in seller has achieved VBV, (2) The dealer can choose to let the embodied solution contact the next highest buyer 430 and proceed to sell the vehicle thus defining the VBV. This process is repeated until such time a buyer successfully completes the purchase, the dealer buys out a buyer's position, or there are no more buyers to complete the purchase and the dealer retains the vehicle and the trade-in seller again achieved the VBV via the original offer from the dealer.

If a vehicle is not sold during a first offer period, the following can be performed. When the same forum is used for operations 402, 404, and 408 and then (i.e., if the vehicle is not sold) again during operations 416 and 418, sellers and buyers may benefit from more transparency on the market place and have more information available to them to make more informed decisions. After all, same vehicles are being transacted in both sets of operations by substantially the same participants.

In certain embodiments, the sale forum comprises one or more webpages for uploading the sale agreement, providing the viewer interface, and/or providing the offering interface. Some examples of sale forum webpages/interfaces are described below.

Even when a forum used for operations 402, 404, and 408 and one used for operations 416 and 418 are the same from implementation standpoint (e.g., the same software, shared database), sellers are buyers have different options during these different sets of operations. The same differences in options apply when forums are different. A brief description of these option differences will now be described. During operations 402, 404, and 408, sellers and buyers do not have any obligations to each other. The sellers merely present information about their vehicles and solicit offers or, more generally, interest from the potential buyers. Once the interest is expressed, a seller and a buyer may proceed with negotiation, which may be through the forum provided by the service provider or outside of the forum. To the contrary, during operations 414, 415, 432, 416 and 418, a trade-in seller has already agreed to sell his or her asset to a dealer for an agreed upon sale price. The trade-in seller has completed the purchase transaction and transferred to the dealer the trade-in vehicle, and had left the dealership in the newly purchased vehicle. However, a trade-in seller and dealer have agreed upon the option of soliciting higher offers from other buyers. This option can be a part of the sales agreement. This option may exist for a predetermined forum listing period, which may be set by the forum or agreed upon by the trade-in seller and buyer. If another party (i.e., a buyer) selects an offer at a higher amount than the trade-in price, the vehicle is transferred to this buyer and the seller receives a higher amount, e.g., a reward share, than otherwise it would have received under the original sale agreement. A typical trade-in transaction does not provide this option or benefit. The vehicle is transferred to the buyer from the dealer. Furthermore, in this example, the dealer receives an entire compensation from the buyer. Alternative, the dealer is obligated to share gain and pays the trade-in seller under the original sale contract a portion due under the sales contract. The new buyer may choose to also enter a trade in vehicle for the newly purchased vehicle from the dealer. By the prior transaction description the process begins anew. These and other functions and features of method 400 are further described below with reference to corresponding operations.

During operation 402, initial vehicle information provided by the seller or the dealer is posted for a predetermined listing period. Examples of this initial vehicle information depend on the type of vehicle and information available to the seller and willingness to be shared by the seller. In an example of selling a vehicle, a seller may post a vehicle identification number, vehicle manufacturer, vehicle model, vehicle trim level, accessories, vehicle mileage, vehicle's and/or seller's location, seller's contact information, asking price, vehicle photos, vehicle condition information, and estimated market value. A forum for posting this information may include an interface for uploading this information and then presenting this information to potential buyers. There may be a fee payable to the service provider for positing this initial vehicle information. If a vehicle is sold as a result of this positing as reflected by decision block 404, then method 400 may be terminated as there is no further need to dispose the vehicle. It should be noted that a buyer that contacts a seller during operations 402, 404, and 408 may offer to purchase a vehicle.

If a vehicle is not sold, as reflected by decision block 404, then method 400 may proceed with relisting the vehicle on the same or different forum. For example, a service provider may allow to relist (with or without addition fee), the same initial vehicle information for another offering period. This additional offering period may be the same or different (e.g., shorter) than the initial listing period. Furthermore, a service provider may require a seller to reduce the price of the vehicle if an additional listing is allowed. In certain embodiments, a seller may quit the process at some operations without proceeding to the next operation. For example, a seller may choose to quit the process after listing (one or multiple times) the vehicle for sale on the initial forum.

At some point in the process 400, a seller may present a vehicle to a dealer as a trade in towards the purchase of a new vehicle 414. The dealer will enter vehicle information, on a dealer listing interface page, such as the vehicle identification number, vehicle make, vehicle model, trim level, color, mileage, reconditioning costs, days to make corrective reconditioning, detailing costs, certification costs, dealer overhead, trade in value offered to the trade in seller, estimated retail value, and other values necessary to providing information about the VTV for potential buyers. The dealer will print and have the trade in seller sign the sales agreement 415. The dealer will have a predetermined time defined in the sales contract to prepare the vehicle 432 for listing on the sales forum. These vehicle preparations may include repairs, detailing, certification, vehicle description, and pictures. The dealer at a later time may edit the listing information concerning condition or pictures. When the dealer has completed the vehicle preparations the dealer completes the listing through the dealer interface page, which is only available to registered dealers of the embodiment, and posted on the website 416.

At some point in the process (operation 410), a seller may present a vehicle to one or more buyers that are in business of buying and selling such vehicles, e.g., dealers. In certain embodiments, the difference between posting initial vehicle information in operation 402 and presenting the vehicle in operation 414 is the type of buyers involved and/or type of information presented to the buyers. A pool of buyers in operation 416 may be substantially more restrictive than pool of buyers in operation 402 and may be limited to dealers, e.g., car dealers when the vehicle is a trade-in vehicle. Furthermore, a seller may present an actual vehicle to a seller during operation 416 as oppose to presenting some description and/or photos as, for example, during operation 402. During operation 416 a buyer may also request to review ownership information, financial information, service information, and other similar types of information about the vehicle.

In certain embodiments, the difference between posting initial vehicle information in operation 402 and presenting the vehicle in operation 414 is the type of buyers involved and/or type of information presented to the buyers. A pool of buyers in operation 416 may be substantially more restrictive than pool of buyers in operation 402 which may or may not be limited to dealers, e.g., car dealers when the vehicle is a wholesale vehicle. Furthermore, a seller may present an actual vehicle to a seller during operation 416 as oppose to presenting some description and/or photos as, for example, during operation 402. During operation 416 a buyer may contact a dealer to request to review ownership information, financial information, service information, and other similar types of information about the vehicle.

Presenting the vehicle to the one or more buyers may be performed automatically by the system after, for example, a seller completes one or more allowed listing/re-listing cycles. During operation 410, the buyer may receive information about such listings/re-listings. Furthermore, operations 410, 412, and 414 may be performed in the context of another transaction with a dealer. For example, in addition to presenting a vehicle to a dealer, a trade-in seller may be also interested in buying another vehicle from the dealer, i.e., performing a so called “trade-in” transaction. In the context of vehicles, a trade-in seller may be interested in selling a used vehicle to a car dealer and buyer another vehicle (e.g., a newer or a new vehicle) from the dealer. However, operations 410, 412, and 414 as well as other operations may be also performed in the context of a simple sale transaction where no other vehicles are involved.

After presenting the vehicle, an offer may presented by the buyer during operation 412 and the offer may be accepted by the seller during operation 404. If the offer is not acceptable to the seller, the system may provide an option of relisting the vehicle back on the “for sale by owner” forum as described above and reflected by decision block 408. Of course, the seller may reject the offer and quit the process.

Once the offer is accepted during decision point 414 and the sale agreement is formed, method 400 may proceed with receiving the sale agreement to sell the vehicle from the seller to the buyer during operation 415. In certain embodiments, this operation involves entering the results of the negotiation process by a trade-in seller and dealer, or both, into the system for offering the vehicle under the sale agreement for further offers. The sale agreement includes at least an agreed upon trade-in price for the vehicle and various information about the vehicle. In certain information, this information may be similar to the information posted by the seller during operation 402 and include a vehicle identification number, vehicle mileage, vehicle location, a vehicle photo, vehicle condition information, and an estimated market value. Such information may be provided by a seller, buyer, or both.

In certain embodiments, upon reaching a purchase agreement, a trade-in seller may be obligated to transfer funds to a dealer (or credit the buyer, for example, in trade-in situations) completing the new or new used vehicle purchase before any further offers for the vehicle are received during operation 418. The funds may correspond to the agreed upon trade-in price and, in certain embodiments, may account for taxes, registration, services fees, and other expenses. In these embodiments, if additional offers are later received and the highest, qualified buyer takes the possession of the vehicle, then this dealer pays an additional sum to the trade-in seller. The additional sum corresponds to the difference between the highest offer and trade-in price paid by the dealer. The additional sum may be minus expenses incurred by the dealer to prep the trade-in vehicle for sale on the sale forum of the service provider. These financial transactions are further explained herein.

In other optional embodiments, no transfer or credit of funds occurs between the buyer and seller prior to the bidding period. The seller simply remains obligated to pay the agreed upon sale price to the buyer after the offering period if no additional bids are made. If one or more bids are posted, the highest bidder becomes responsible for purchasing a vehicle and the seller is released from his or her initial responsibility. In these embodiments, the highest bidder may be instructed to allocate some of the bid amount to the seller, e.g., to credit for purchase of a new or newer car in a trade-in scenario or to compensate the dealer for inspecting the vehicle and costs associated with initial negotiations and positing the sale agreement information. Again, these financial transactions are further explained below.

Once the sale agreement information is received by the system during operation 415, the system may post the offer price points or offer levels price for the vehicle and information about the vehicle on a sale forum accessible to potential buyers during operation 416. As noted above, this sale forum may be the same forum used during operations 402 or it may be a different form. The information provided to the forum may be viewable to the potential buyers through a viewing interface. Specifically, a system may provide a viewing interface for viewing the offer price points for the vehicle and information about the vehicle. The viewing interface may be a part of the sale forum accessible to the buyers. The viewing interface may be accessible from various types of computer systems used by buyers. Various examples of such systems (e.g., laptops, netbooks, tablet computers, handheld electronics, mobile phones, et al.) are described herein.

The system may also provide an offering interface for posting one or more offers from the buyers during the predetermined listing period. The offering interface is also a part of the sales forum accessible to the buyers. In certain embodiments, the offering interface is different from the viewing interface. A buyer may need to provide certain login information in order to enter the offering interface and be able to post an offer or meet a listed offer. In certain embodiments, the system may require a buyer to pay or otherwise secure a deposit prior or during offer posting. This requirement may be used to minimize and eliminate illegitimate offers that would other disturb the process and make the overall process unreliable and even unworkable.

The offering interface may only allow posting offers that have an offering price higher than the agreed upon sale of the trade-in vehicle price, which is greater than the trade-in amount given to the trade-in seller. When the offers are posted, the system may notify the trade-in seller and/or the dealer about new offers. In certain embodiments, the buyer may be offered an option to participate in the offering process by, entering, for example a higher offer. Optionally a more qualified buyer may be invited to meet an offer of a less qualified buyer. The current offer that has been posted or the offer greater than the currently posted offer may be also viewable through the viewing interface and/or offering interface to potential buyers. In certain embodiments, all offers may be hidden till the end of the offering time period. The viewing interface and/or offering interface may also have information on vehicle value (e.g., KELLY BLUE BOOK® estimates for vehicles), comparable listings, sales results from previous listings, and other similar information. An offering interface may allow posting a current offer and/or a maximum offer. If the maximum offer amount is provided, the system may automatically increase the offer points or levels (i.e., up the amount of the maximum bid) if the previously posted offer for this buyer was exceeded.

In certain embodiments, the viewing interface and/or offering interface may provide information about the actual physical location of the vehicle and how the vehicle can be viewed by the potential buyers. For example, after the sale agreement was reached, the vehicle may be transferred to the dealer (initial buyer). The dealer that lists on the sales forum may be required to provide reasonable accommodations for viewing the vehicles by potential buyers. In the content of trading-in an older car, the dealer may keep this older car on the lot prior to and during the offering period and allow potential buyers to view, inspect and test drive the vehicle, e.g., view, sit in or test drive car. The dealer may be compensated for this service by, for example, splitting with the trade-in seller the premium that the highest buyer will pay over the trade-in sale price of the car that appears in the sale agreement between the dealer and trade-in seller. This premium sharing approach may be used to incentivize the dealer to make the vehicle available for viewing and inspection. Of course, the incentive to getting out of the ownership of the vehicle may be sufficient for the dealer to make the car available for viewing. Dealers may wish to quickly remove a vehicle from inventory due to physical condition, brand misalignment, market pressures, financial risk or combinations thereof.

Method 400 may proceed with determining if any offers are posted during the predetermined listing period as shown with decision block 418. If any offers are posted through the offering interface, then the system may automatically select the highest buyer, i.e., the buyer that posted the highest offer price for the vehicle presented on the sales forum. This operation may be repeated recursively after posting new offers. When the highest buyer is selected, method 400 may proceed with instructing the highest buyer to post the payment during operation 422. The payment may be posted through the sale forum, through an independent system (with a confirmation by the independent system received by the sale forum), or directly between the parties with one or more receiving parties providing confirmation into the sale forum, for example.

Method 400 may require the dealer to reoffer the vehicle due to failure of a buyer to be able to complete the payment transaction to one or all required participants. By example, if the highest buyer 422 is unable to secure financing, the buyer cannot complete the new vehicle purchase. In this instance, the system will identify the next highest buyer(s) 426 and the buyer's offer placed on the vehicle during the listing period 418. If a buyer exists, then the system will notify the dealer 428 of the next highest buyer's offer was during the listing period 418. The dealer can proceed with sale of the vehicle to this next buyer. The dealer also has the option to buy out the next buyer's position. This requires the dealer to make a payment to the trade-in seller per the sales agreement and the next highest buyer is not contacted. At this time the sales agreement is completed with the transfer of final funds. If the dealer does not utilize the buyout, the next highest buyer is contacted.

The reoffer described above can be limited in the number of times a vehicle can be reoffered or by a set reoffer period. If the number of reoffers of a vehicle exceeds the maximum number of reoffers, then the vehicle cannot be put through this process again. If the reoffer is limited by a time period, then after that time has elapsed, then the vehicle cannot be reoffered. The reoffer process can also have a minimum number of times or a minimum time period. As an example, the minimum reoffers can be set at four and the maximum at ten. As an example, the time period for reoffers can be between one day or one week and a month.

The predetermined listing period may be a specific number of days set by the sale forum. This period may be determined based on the sales history on the sales forum, the type of the vehicle, value of the vehicle, fee payable by the trade-in seller and/or dealer, and other similar factors. In certain embodiments, the period is the same for all vehicles. The predetermined listing period may be determined by the trade-in seller and/or dealer during negotiations of the sale agreement and be a part of the sale agreement.

Method 400 may use predetermined offer value “point points” to promote upward value, eliminate time wasted in auction type bidding, and promote active buyers. Price points are predetermined values used buyer for placing an offer on a vehicle listed as “trade in” or “wholesale”. The values may by example be ten values between the trade in value and a target retail value. Each value may be constant or non-constant value. The trade in and target retail value may be established by the trade in seller and dealer and will be recorded in the sales agreement. The first value point above the trade in value may include dealer reconditioning cost, qualifying cost typical with a certified used vehicle, a specific dealer overhead factor, and others prelisting values. The retail value can be used to set the value at a predetermined price point. For example if the retail value is at price point seven, the price points eight and ten would represent high vehicle value and a higher financial return to the trade in seller. Price points eight through ten represents a higher then dealer expected value, and therefore, returns more value to the trade in seller. Price points below point seven would represent expected value by the dealer and the value return to the trade in seller would be less. All value point offers improve the trade in seller's financial outcome. Price points allow the buyer to place their offers and wait for the outcome of the listing. An auction method force buyer to attend the last time segment to augment the bid to potentially secure a vehicle. The price points promote being first and highest, or right valued, and eliminate the need to return to the listing at the end of the listing period.

The price points may be used in “trading in” and “wholesale” listing. The price points for the trading in listing may be agreed upon by the trade in seller and the dealer and recorded in the sales agreement. The price points in the wholesale listing are determined by the dealer entries into the system.

The first buyer selecting the highest value will be instructed to complete the purchase of the vehicle from the dealer. This provides highly motivated buyers the option to purchase a vehicle without waiting till the end of the listing period. The listing period will continue until notification from the dealer that the vehicle transaction has been completed. In this instance, the trade in seller will receive maximum value for the trade in vehicle.

Each price point has a “share reward” to the trade in seller and dealer. The shared reward may be a constant or non-constant value. The shared reward for trade in listings may be determined by the trade in seller and the dealer. The shared reward for a trade in vehicle transferring from the trade in seller to a dealer, and to a wholesale listing may be determined by the trade in seller and the dealer. A wholesale listing by a dealer there is no shared reward value as the dealer has no sales agreement with the vehicle.

Method 400 may also involve instructing the dealer or the seller to transfer the vehicle to the highest buyer, for example, after the payment is posted by the highest buyer. The vehicle may be with the dealer at this point as explained herein. For example, the vehicle may be transferred from the trade-in seller to the dealer after completing the sale agreement. In many instances, the dealer may be more suitable for showing and later transferring the vehicle to potential third party buyer(s).

If no bids are posted through the listing interface, then method 400 may proceed with instructing the dealer to pay the agreed upon sale price (or some other equivalent, e.g., the sale price less taxes, fees, preparation charges, repair costs and the like) during operation 420. This operation is optional as the funds corresponding to the sale price may have already been transferred from the dealer to the trade-in seller after reaching the sale agreement. For example, the vehicle may be transferred from the trade-in seller to the dealer prior to posting the sale price for the vehicle and information about the vehicle on the sale forum of the service provider.

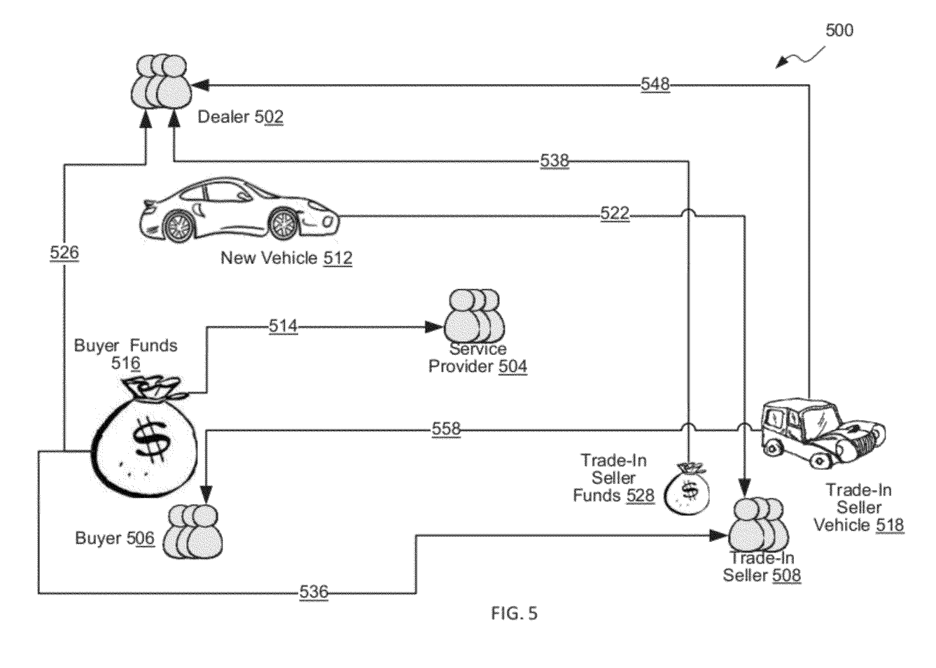

FIG. 5 is a process flowchart 500 corresponding to vehicles and fund flows between various participants, in accordance with certain embodiments. Some of these flows are enabled by computer-implemented methods and computer systems described in this document. Other flows may be conducted outside of the system but may still be influenced by various data outputs of the system. Examples of these flows will now be described.

Trade-in seller 508 may have trade-in vehicle 518 (e.g., a used car) but actually want new vehicle 512 available from buyer/dealer 502. Seller 508 may also have seller funds 528, which may be sufficient to pay for the price difference between a new vehicle 512 and a trade-in vehicle 518. Buyer 506 may have buyer funds 516 to pay for a trade-in vehicle 518.

In one example, trade-in seller 508 may offer the trade-in vehicle 518 directly to buyer 516 using, e.g., a “for sale by owner” listing provided by the system and agrees upon the price. This bypasses the dealer 502 at this point in the sale. In this example, buyer 506 transfers funds 516 to seller 508 (as shown by arrow 536) and receive the proposed trade-in vehicle 518 directly from trade-in seller 508 (as shown by arrow 558). Seller may later transfer combined funds (528 and 516) or some portion thereof to dealer (as shown by arrow 538) and receive new car 512 (as shown by arrow 522). At this stage, in this example, all transfers may be completed without service provider 504 receiving any funds. If the seller uses the sales forum, then the seller would owe a fee to the service provider.

In another example, buyer 506 may not learn about potential trade-in vehicle 518 from seller 508 when it is offered directly by seller 508 or agreement between buyer 506 and seller 508 may not be reached at this point (e.g., the asking price was too high, transfer process was too complicated insufficient funds, or lack of available financing). In this case, seller 508 negotiates with dealer 502 and reaches some sale agreement for trade-in vehicle 518. As a part of this agreement, seller 508 also receives new car 512, transfers seller, trade-in vehicle 518 to dealer (buyer) 502, and pays seller funds 528 for any difference. Some or all of these transactions may be postponed until after the listing period is complete. During the listing period, buyer 506 may agree to purchase trade-in vehicle 518 for an acceptable offer amount that is higher than the trade-in price agreed upon between seller 508 and dealer 502. At this point, buyer 506 may pay a portion of buyer funds 516 to service provider 504 (as shown by arrow 514). The remaining funds may go to dealer 502 (as shown by arrow 526). In return, dealer 502 may deliver trade-in vehicle 518 to buyer 506. The dealer 502 sends the shared reward portion to the trade-in seller 508. Some variations of these transactions are possible and generally depend on whether trade-in vehicle 518 and trade-in funds 528 have been transferred to dealer 502 previously.

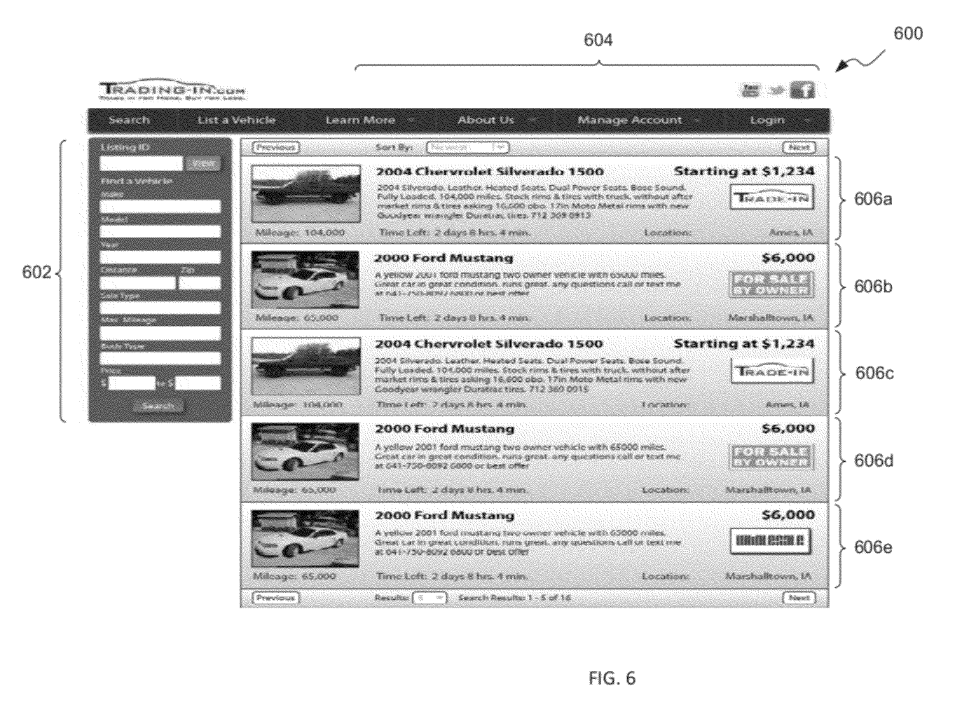

FIG. 6 illustrates a viewing interface 600 presenting different types of listings, in accordance with certain embodiments. Viewing interface 600 may include search portion 602, into which third parties, e.g., buyers, searching for vehicles may enter various searching criteria. In an example of selling cars, searching criteria may include make, model, year, proximity of the car to the identified location, year range, price range, body type, mileage, trim package, text field, listing type (trade in, wholesale, for sale by owner) and the like. Viewing interface 600 also includes listing portion 604 with multiple listings 606a-606e. Listing portion 604 may include different types of listing. For example, FIG. 6 shows listings 606a and 606c being “trade-in” listings representing cars that are currently under contracts for certain sale prices. FIG. 6 also shows listings 606b and 606c being “for sale by owner listings.” FIG. 6 also shows listings 606e being “wholesale” vehicle listings. The difference between these types of listings is described elsewhere in this document.

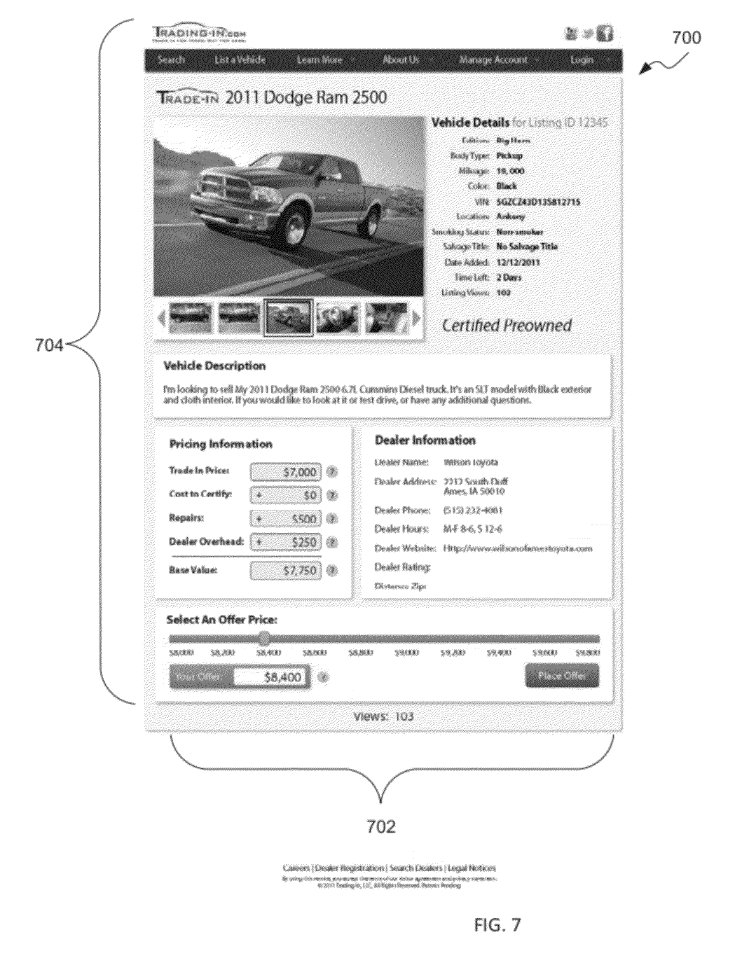

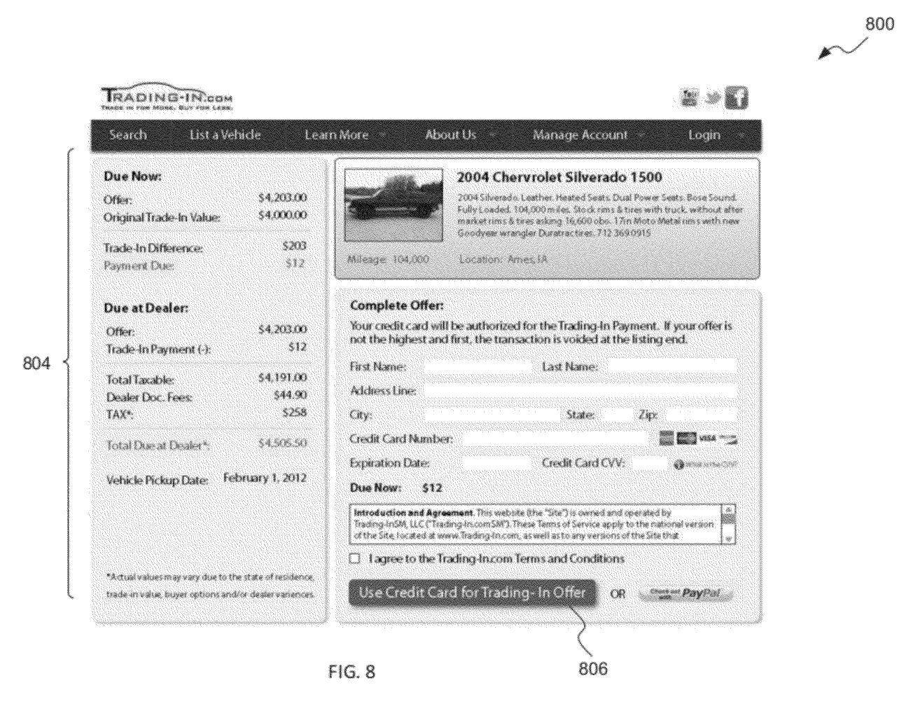

FIG. 7 illustrates an initial reviewing and offering interface 700, in accordance with certain embodiments. Initial reviewing and offering interface 700 has an offering portion 702, where a buyer can present and post to the service provider's system his or her current offer, and vehicle information portion 704, where a buyer can learn more information about the vehicle. For example, vehicle information portion 704 may include photos, description, dealer comments, suggested repairs, additional options offered by dealer and other features and information. When a buyer selects an offer amount in offering portion 702, initial offer interface 700 may be replaced with another offer interface 800 shown in FIG. 8. Offer interface 800 is shown to have offer information portion 804, which includes various additional details about the offer such as the price selected in bidding portion 702, amount payable to service provider (e.g., charges to the credit card) in case of a winning offer, the remaining amount payable to other parties (e.g., to a dealer), an option for a third-party to trade in his or her own car, a financing option, selection of additional options and services, and the like. Offer information portion 804 may also include a button that actually places (e.g., posts to the service provider system) an offer.

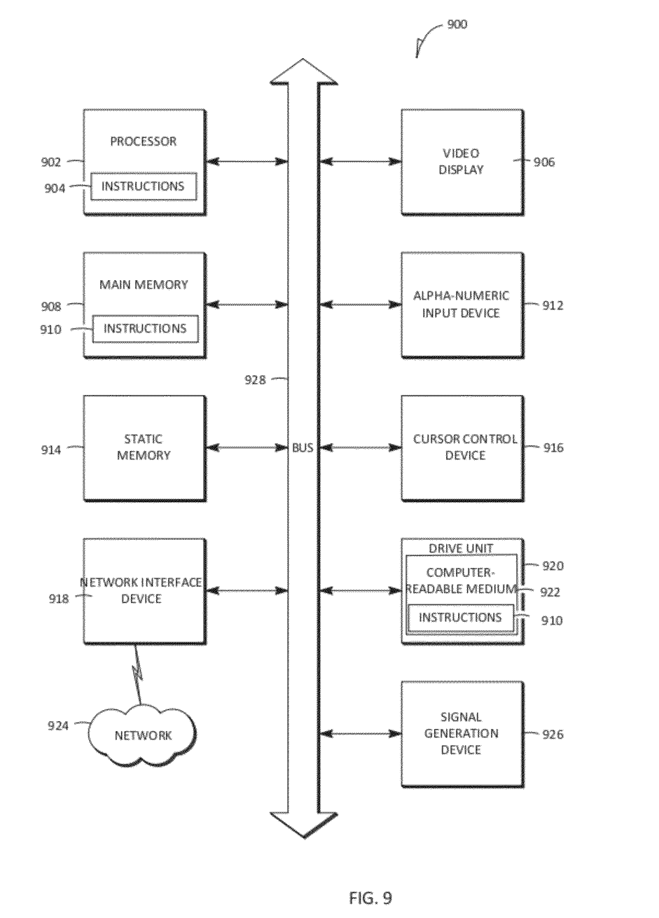

FIG. 9 is a diagrammatic representation of an example machine in the form of a computer system 900, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor or multiple processors 902 (e.g., a central processing unit (CPU), a graphics processing unit (GPU), or both), and a main memory 908 and static memory 914, which communicate with each other via a bus 928. The computer system 900 may further include a video display unit 906 (e.g., a liquid crystal display (LCD)). The computer system 900 may also include an alphanumeric input device 912 (e.g., a keyboard), a cursor control device 916 (e.g., a mouse), a voice recognition or biometric verification unit, a disk drive unit 920, a signal generation device 926 (e.g., a speaker) and a network interface device 918. The computer system 900 may further include a data encryption module (not shown) to encrypt data.

The disk drive unit 920 includes a computer-readable medium 922 on which is stored one or more sets of instructions and data structures (e.g., instructions 910) embodying or utilizing any one or more of the methodologies or functions described herein. The instructions 910 may also reside, completely or at least partially, within the main memory 908 and/or within the processors 902 during execution thereof by the computer system 900. The main memory 908 and the processors 902 may also constitute machine-readable media.

The instructions 910 may further be transmitted or received over a network 924 via the network interface device 918 utilizing any one of a number of well-known transfer protocols (e.g., Hyper Text Transfer Protocol (HTTP)).

While the computer-readable medium 922 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware. The instructions for the method may be stored in a tangible media. The instructions may be in any location that can be sensed or read by a machine.

While many of the present embodiments of the present invention were described with a seller offering its item or vehicle to a dealer as part of a trade-in transaction, other examples are part of the present disclosure. For example, the service provider may provide a seller an option to present his or her vehicle directly to third parties before contracting any buyers, e.g., the dealer. If a sale is completed, then the service provider may be paid by either the seller of the buyer. The service provided may merely introduce the buyer and seller and not be part of the actual transfer transaction. The service provider may provide a transfer form for execution by the seller and buyer. However, this option may not generate any interest or sale of the vehicle. If this is the case, then the seller proceeds with entering into a sale agreement with the dealer.

Examples of the present invention are shown on www.trading-in.com, which includes a method and interface after completion of the listing period and/or the final purchase of the vehicle of allowing the trade-in seller to provide a feedback rating of dealer performance during the trade-in transaction. The buyers of a trade-in have an interface that also allows for providing a feedback rating of the dealer performance. The method also provides an interface for dealers to address the trade-in seller's feedback and buyer's feedback. This information is accumulated and presented to future trade-in sellers and buyers to provide value and expectations and improvements. An example of seller and buyer feedback is found in U.S. Pat. No. 7,774,350, which is hereby incorporated by reference only as to a seller/buyer feedback system that may be implemented with the present methods and systems.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A computer-implemented method for offering a trade-in vehicle under a sale agreement for further offers, the computer implemented method comprising:
storing, in a memory, the sale price for the vehicle and information concerning the vehicle for a sale forum accessible to buyers for an offering period;
outputting a viewing interface for viewing the sale price of the vehicle and the information concerning the vehicle, the viewing interface being a part of the sale forum accessible to the buyers;
providing a bidding interface for posting one or more offers from the buyers during the offering period, the offering interface being a part of the sale forum accessible to the buyers, wherein each of the one or more bids comprises a offering price for the vehicle that is higher than the sale price;
determining, using a processor, that the one or more offers are posted through the offering interface;
based on the determination, automatically selecting, using a processor, a first highest offer that posted a highest offer price for the vehicle presented in the one or more offers; and
outputting a selected instruction to the buyer to transfer the vehicle to the highest buyer offer.

2. The computer-implemented method of claim 1, wherein the vehicle is selected from a group consisting of: a vehicle, a boat, a motorcycle, and farming equipment.

3. The computer-implemented method of claim 1, further comprising transferring the vehicle from the trade-in seller to the dealer prior to posting the vehicle for sale on the sales forum.

4. The computer-implemented method of claim 1, wherein the buyer of the trade-in vehicle is a car dealership.

5. The computer-implemented method of claim 1, further comprising, prior to receiving the sale agreement, posting an initial vehicle information provided by the seller for a predetermined offering period.

6. The computer-implemented method of claim 5, wherein the initial vehicle information is viewable through the viewing interface of the sale forum.

7. The computer-implemented method of claim 6, wherein the initial vehicle information is distinguishable from the posting of the price for the vehicle and the information concerning the vehicle provided within the sale agreement in the viewing interface of the sale forum.

8. The computer-implemented method of claim 5, further comprising, prior to receiving the sale agreement and after posting the seller's offer, posting a new seller's offer for the vehicle on the selling forum for the initial predetermined period of time.

9. The computer-implemented method of claim 1, wherein the information about the vehicle comprises one or more pieces of information selected from the group consisting of: a vehicle identification number, vehicle mileage, a vehicle location, a vehicle photo, vehicle condition information, and an estimated market value.

10. The computer-implemented method of claim 1, wherein the listing period is for a specific number of days set by the sale forum.

11. The computer-implemented method of claim 1, wherein the listing period is a part of the sale agreement and is agreed upon by the trade-in seller and the dealer.

12. The computer-implemented method of claim 1, wherein the sale agreement is received at a computer of the service provider from the dealer.

13. The computer-implemented method of claim 1, wherein the sale forum comprises one or more webpages for uploading the sale agreement, providing the viewer interface, and/or providing the buyer interface.

14. The computer-implemented method of claim 1, wherein the viewing interface further comprises information associated with vehicle's location and vehicle's availability for viewing by the buyers.

15. The computer-implemented method of claim 1, further comprising instructing the highest buyer to pay a sum corresponding to the highest offer price to the dealer.

16. The computer-implemented method of claim 1, further comprising instructing the selected buyer to pay a portion of the highest offer price corresponding to the sale price to the dealer and a remaining portion of the highest offer price to the trade-in seller, wherein a remaining portion of the highest offer price corresponds to a difference between the highest offer price and the trade-in value.

17. The computer-implemented method of claim 1, further comprising instructing the dealer to pay a reward share to the seller when reward conditions are met upon sale of the trade-in vehicle.

18. The computer-implemented method of claim 1, further comprising collecting the highest offer from the selected buyer.

19. The computer-implemented method of claim 1, wherein the one or more offers posted at the sales forum during the period of time is viewable to potential buyers.

20. The computer-implemented method of claim 1, further comprising receiving a sale agreement to sell the vehicle from a seller to a buyer, the sale agreement comprising a sale price for the vehicle and information concerning the vehicle.

21. The computer-implemented method of claim 1, further comprising outputting an instruction to an alternate buyer if the original highest offer buyer is unable to complete the purchase of the vehicle.

22. The computer-implemented method of claim 21, wherein outputting the alternate buyer instruction includes providing an interface to the dealer with information about the next buyer offer so the dealer can determine whether to allow the next highest buyer to complete the transaction or retain the trade-in vehicle.

23. The computer-implemented method of claim 1, further comprising providing an interface to the trade-in seller for evaluating the dealer service and satisfaction during the trade-in transaction.

24. The computer-implemented method of claim 1, further comprising providing an interface to the trade-in buyers for evaluating the dealer service and satisfaction during the trade-in buying transaction after a completed listing on the computer implemented method.

25. A computer-implemented system for offering a vehicle under a sale agreement for further bidding, the system comprising:
a buyer interface module to receive vehicle sale information from a dealer;
a posting module to post an offer and incremental offers for the sale of the vehicle and information about the vehicle on a sale forum accessible to buyers for an offer period;
an offer evaluation module to receive one or more offers from the buyers during the offer period, wherein each of the one or more offers comprises an offer amount for the vehicle that is higher than a sale price set by the dealer, the offer evaluation module is to automatically select a highest bidder that posted a highest offer price for the vehicle presented in the one or more offers and instructing the dealer to transfer the vehicle to the highest offerer.

26. The system of claim 25, wherein the offer evaluation module is to select a most-qualified buyer when two buyers submit the same offer.

27. The system of claim 25, wherein the offer evaluation module selects the most-qualified buyer based on a first buyer to submit an offer.

28. The system of claim 25, wherein the offer evaluation module selects the most-qualified buyer based on a review rating of the buyer.

29. The system of claim 25, wherein the offer evaluation module selects the most-qualified buyer based on a credit score, financing or both.

30. The system of claim 25, wherein the offer evaluation module selects the most-qualified buyer based on a trade-in vehicle from the buyer.

31. A machine-readable medium comprising instructions for offering a vehicle under a sale agreement for further bidding, which when implemented by one or more processors, performs the following operations:
receive a sale price and information concerning the vehicle;
post the sale price of the vehicle and information concerning the vehicle on a sale forum accessible to bidders for an offer period;
provide a viewing interface to view the sale price of the vehicle and information concerning the vehicle, the viewing interface being a part of the sale forum accessible to the bidders;
providing a offer interface to post one or more bids by the bidders during the offer period, the offer interface being a part of the sale forum accessible to the buyers, wherein each of the one or more offers comprises an offer price for the vehicle that is higher than the sale price;
determining that the one or more offers are posted through the bidding interface;
based on the determination, automatically selecting a highest buyer that posted a highest price for the vehicle presented in the one or more offers; and
selectively instructing the dealer to transfer the vehicle to the selected buyer.
